(19) United States
(12) Patent Application Publication
(10) Pub. No.: US 2002/0052823 A1
(43) Pub. Date: May 2, 2002

(54) Authentication method, information processing method and recording medium

(76) Inventors: Soichi Nemoto, Kawasaki (JP); Toru Ozaki, Kawasaki (JP); Yukihiro Araki, Kawasaki (JP); Kazutaka Saito, Kawasaki (JP); Hidefumi Aoe, Kawasaki (JP)

Correspondence Address: STAAS & HALSEY LLP, 700 11TH STREET, NW, SUITE 500, WASHINGTON, DC, 20001, US

(21) Appl. No.: 09/812,828

(22) Filed: Mar. 21, 2001

(30) Foreign Application Priority Data
Nov. 1, 2000 (JP) 2000-334500

(51) Int. Cl. G06F 17/60

(52) U.S. Cl. 705/37

(57) ABSTRACT

There is provided an authentication method capable of promptly identifying a real holder of securities and providing holders with useful information. A holder identifying unit compares customer information with transaction information so that a real holder of securities can be identified after a related transaction. The associated information is stored in a storage unit via a holder information registering unit. A retrieval unit acquires holder information concerning a securities issuance company that owns an information processing apparatus in response to a request for downloading holder information from the storage unit. An information sending unit refers to the holder information stored in the storage unit, and sends related items of holder information to the holder.

### BACKGROUND OF THE INVENTION

1. Field of the Invention

The present invention relates to an authentication method, an information processing method and a recording medium. More particularly, the present invention is concerned with a method and a recording medium for authenticating a holder of securities, and a method and a recording medium for performing information processing that uses holder information concerning the holder of securities obtained by an authentication processing apparatus for authenticating the holder of securities.

2. Description of the Related Art

Generally, securities such as stocks and bonds are traded so that a buy order is matched with a sell order or vice visa and a buyer-seller contract (agreement) is then made. An investor remits money to a securities company via which the investor has performed the transaction within three business days from the date of agreement. Also, the securities company settles the account after three business days from the date of agreement.

The securities themselves (sheets of paper) do not actually move by the buying and selling thereof. The investors authorize the securities company to deposit securities. The securities company manages the securities in such a way as to authorize a custody-of-securities institution to re-deposit securities.

The securities company receives information about the holders of securities from the custody-of-securities institution. The public company makes a list of real holders of securities based on the information supplied by the securities company. In practice, the public company entrusts the work of registering information in the list with a trust bank or the like.

Therefore, it takes a certain time for the public company to actually receive related information after the agreement is made between the buy order and the sell order and the securities are transferred. This makes it difficult for the public company to identify the real holders of securities.

### SUMMARY OF THE INVENTION

Taking the above into consideration, an object of the present invention is to provide an authentication method capable of easily identifying a real holder of securities.

To accomplish the above object, according to the present invention, there is provided a method for authenticating a holder of securities comprising the steps of: storing customer information concerning customers in a storage unit; acquiring transaction information concerning a transaction that has been agreed in an exchange; and identifying a holder of securities after the transaction by comparing the transaction information with the customer information.

To accomplish the above object, according to the present invention, there is also provided a method for performing an information process using holder information concerning a holder obtained by an authentication apparatus which authenticates a holder of securities. The method includes the steps of: acquiring the holder information; storing the holder information in a storage unit; and selecting a given item of holder information from among the holder information stored in the storage unit and sending given information to a holder related to the given item of holder information selected.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a block diagram illustrating the principle of the present invention;

FIG. 2 is a block diagram of a system configuration according to an embodiment of the present invention;

FIG. 3 is a block diagram of a configuration of a securities company server shown in FIG. 2;

FIG. 4 is a functional block diagram of the securities company server that is working;

FIG. 5 is a functional block diagram of a public company server that is working;

FIG. 6 illustrates an example of a screen that is displayed at an investor client when a customer registration is made with respect to the securities company server;

FIG. 7 illustrates an example of customer information registered in the securities company server;

FIG. 8 illustrates another example of the screen that is displayed at the investor client when the customer registration is made with respect to the securities company server;

FIG. 9 illustrates an example of a screen that is displayed at the investor client when stock is bought or sold;

FIG. 10 is a diagram of a format of a buy or sell order that is sent to a securities exchange server from the securities company server;

FIG. 11 is a diagram of a format of agreement that is sent to the securities company server from the securities exchange server when agreement is made;

FIG. 12 illustrates an example of real stockholder information of record in a real stockholder information management program;

FIG. 13 illustrates an example of real stockholder information stored in the public company server;

FIG. 14 illustrates an example of a screen used to set a condition at the time of sending a direct mail via which the public company server informs a real stockholder of a stockholders' meeting;

FIG. 15 illustrates an example of an e-mail that is sent to real stockholders when a “send” button is clicked on the screen shown in FIG. 14;

FIG. 16 illustrates an example of a screen that is displayed when a URL for referring to a bill is clicked on the screen shown in FIG. 15;

FIG. 17 illustrates an example of a screen that is used for authentication and appears when an “exercise of voting right” is clicked on the screen shown in FIG. 16;

FIG. 18 illustrates an example of a screen that is displayed when an “OK” button is clicked and authentication is successful;

FIG. 19 illustrates an example of a screen that is displayed when authentication fails though the “OK” button is clicked;

FIG. 20 illustrates an example of a screen that is displayed when a condition for sending a direct mail regarding a document of business strategy to the real stockholders from the public company server is set;

FIG. 21 illustrates an example of an e-mail that is sent to the real stockholders when a “send” button is clicked on the screen shown in FIG. 20;

FIG. 22 illustrates an example of a screen that is displayed when a hot text “3. PREDICTION OF CHANGE OF MARKET SCALE” shown in FIG. 21;

FIG. 23 illustrates an example of a screen used to set a condition for sending a direct mail regarding stockholder preference information to real stockholders from the public company server;

FIG. 24 illustrates an example of an e-mail that is sent to the real stockholders when an “OK” button shown in FIG. 23;

FIG. 25 illustrates an example of a screen that is used to apply for goods and is displayed when an “apply” button shown in FIG. 24 is clicked;

FIG. 26 is a block diagram of another embodiment of the present invention;

FIG. 27 is a flowchart of an example of a process executed by the securities company server when an investor is registered as a new customer;

FIG. 28 is a flowchart of an example of a process that is executed by the securities company server when the investor buys stock;

FIG. 29 is a flowchart of an example of a process executed by the securities company server in order to identify the real stockholder after he or she buys stock;

FIG. 30 is a flowchart of an example of a process that is executed by the securities company server when a request for downloading real stockholder information from the public company server is issued;

FIG. 31 is a flowchart of an example of a process that is executed by the public company server when the real stockholder information is sent from the securities company server; and

FIG. 32 is a flowchart of an example of a process that is executed when a direct mail is sent to real stockholders from the public company server.

### DESCRIPTION OF THE PREFERRED EMBODIMENTS

Embodiments of the present invention are described with reference to the accompanying drawings.

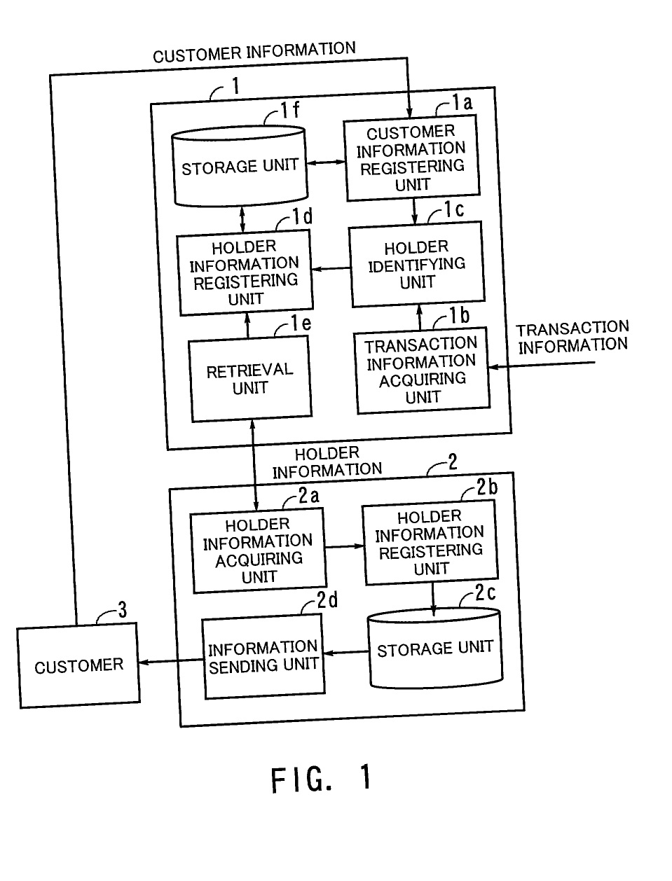

FIG. 1 is a block diagram illustrating the principle of the present invention. Referring to this figure, a system is made up of an authentication apparatus 1 and an information processing apparatus 2 according to the present invention. The authentication apparatus 1 includes a customer information registering unit 1a, a transaction information acquiring unit 1b, a holder identifying unit 1c, a holder information registering unit 1d, a retrieval unit 1e, and a storage unit 1f. The authentication apparatus 1 identifies the real holders of securities on the basis of transaction information and customer information.

The information processing apparatus 2 includes a holder information acquiring unit 2a, a holder information registering unit 2b, a storage unit 2c, and information sending unit 2d. The information processing apparatus 2 acquires holder information concerning the real holders of securities from the authentication apparatus 1, and sends given information to the holders.

The customer information registering unit 1a registers customer information concerning a customer 3 in the storage unit 1f. The transaction information acquiring unit 1b acquires information concerning a transaction that has been agreed in a securities exchange. The holder identifying unit 1c compares the transaction information supplied from the transaction information acquiring unit 1b with the customer information registered by the customer information registering unit 1a, and thus identifies the holder of securities after the transaction. The holder information registering unit 1d associates information concerning the holder identified by the holder identifying unit 1c with information concerning a person who issues securities, and registers associated information in the storage unit 1f as holder information. When the authentication unit 1 receives a request for retrieval from the information processing apparatus 2, the retrieval unit 1e retrieves the storage unit 1f to search for information about the corresponding holder. The storage unit 1f stores the customer information and the holder information.

The holder information acquiring unit 2a acquires holder information about securities from the authentication apparatus 1. The holder information registering unit 2b registers the holder information acquired by the unit 2a in the storage unit 2c. The information sending unit 2d selects information about the requested holder from among the holder information stored in the storage unit 2c, and sends the selected holder information to the corresponding holder.

The system shown in FIG. 1 operates as follows.

The transaction information registering unit 1a registers attribute information (name, address, telephone number) concerning a customer 3 in the storage unit 1f.

The transaction information acquiring unit 1b acquires information concerning a transaction (hereinafter simply referred to as transaction information) when a buyer of securities and a seller have reached an agreement. The transaction information includes the date of transaction, persons involved in the transaction, the volume and price of securities to be traded. The holder identifying unit 1c compares the transaction information with the customer information, and identifies the new holder of securities after the transaction. The holder information registering unit 1d associates the information about the holder identified by the holder identifying unit 1c with information concerning the person who issues the securities, and registers associated information in the storage unit 1f as holder information.

The authentication apparatus 1 would receive a retrieval request about the holder of securities from the information processing apparatus 2. In this case, the retrieval unit 1e retrieves the storage unit 1f to search for holder information concerning securities issued by the company that owns the information processing apparatus 2, and sends information searched for to the apparatus 2. The holder information registering unit 2b registers the holder information acquired by the holder information acquiring unit 2a in the storage unit 2c. The information sending unit 2d refers to the holder information, and sends given information stored in the storage unit 2c to the securities holder. For example, if the company equipped with the information processing apparatus 2 is a public company that issues stock certificates as securities, the customer 3 corresponds to a stockholder who holds stock certificates of that company. In this case, the information sending unit 2d sends information about preference to the stockholders.

As described above, according to one aspect of the present invention, the transaction information is compared with the customer information to thereby identify the holder of securities. This makes it possible to identify the real holder of securities immediately after the transaction.

Also, according to another aspect of the present invention, the information processing apparatus 2 downloads desired holder information from the authentication apparatus 1, and supplies information created based on the downloaded holder information to the customer 3 who holds the securities. This makes it possible to send useful and informative information to the customer 3 (the real holder) who does not appear in the periodically published holder list but actually owns the securities.

A description will now be given of an embodiment of the present invention.

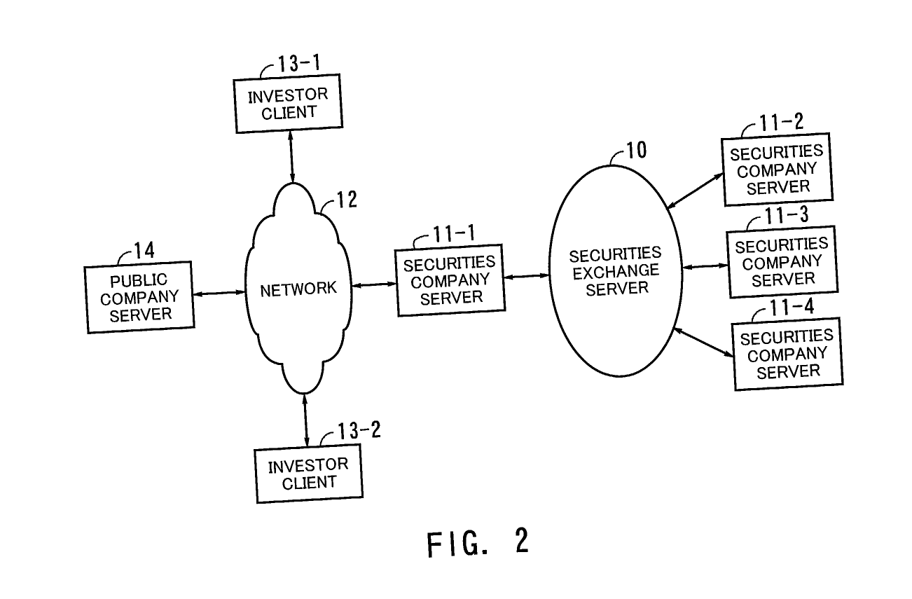

FIG. 2 is a block diagram of a system according to an embodiment of the present invention. The system includes a securities exchange server 10, securities company servers 11-1 through 11-4, a network 12, investor clients 13-1 and 13-2, and a public company server 14.

The securities exchange server 10 is a server installed in a securities exchange. The server 10 receives buy and sell orders sent by the securities company servers 11-1 through 11-4, and executes a given process for the buying and selling of securities. The securities company servers 11-1 through 11-4, which are installed in securities companies, sends buy and sell orders from the investors to the securities exchanger server 10. The network 12 may, for example, be the Internet via which information is transferred among the securities company servers 11-1 through 11-4, the investor clients 13-1 and 13-2, and the public company server 14. The investor clients 13-1 and 13-2 are owned by investors and may, for example, be personal computers or the like. The public company server 14 is owned by a public company that lays securities open to the market.

The securities exchange server 10, the securities company servers 11-1 through 11-4, and the public company server 14 may have an identical structure. Thus, by way of example, the securities company server 11 is described immediately below.

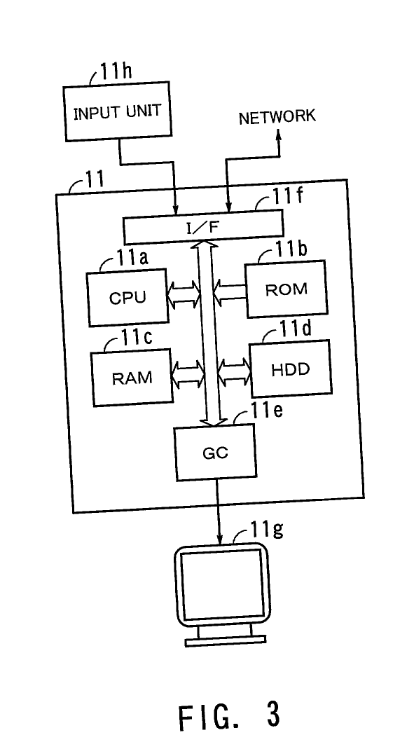

FIG. 3 is a block diagram of a structural configuration of the securities company server 11. The server 11 includes a CPU (Central Processing Unit) 11a, a ROM (Read Only Memory) 11b, a RAM (Random Access Memory) 11c, an HDD (Hard Disk Drive) 11d, a GC (Graphics Card) 11e, and an I/F (InterFace) unit 10f.

The CPU 11a executes various operational processes to control the other components in accordance with programs stored in the HDD 11d. The ROM 11b stores basic programs to be executed and data to be processed by the CPU 11a. The RAM 11c stores a program currently being executed by the CPU 11a and temporarily stores data being processed therein. The HDD 11d stores other programs to be executed by the CPU 11a and data related to buy and sell orders. The GC 11e executes a drawing process in accordance with a drawing instruction supplied by the CPU 11a, and converts a resultant image into an image signal, which is then supplied to a display unit 11g. The I/F unit 11f converts a format of data from an input unit 11h into another given format, and performs data format conversions and protocol conversions in a data transfer via the network or the like. The input unit 11h may, for example, be a keyboard and a mouse. The display unit 11g may, for example, a CRT (Cathode Ray Tube) monitor.

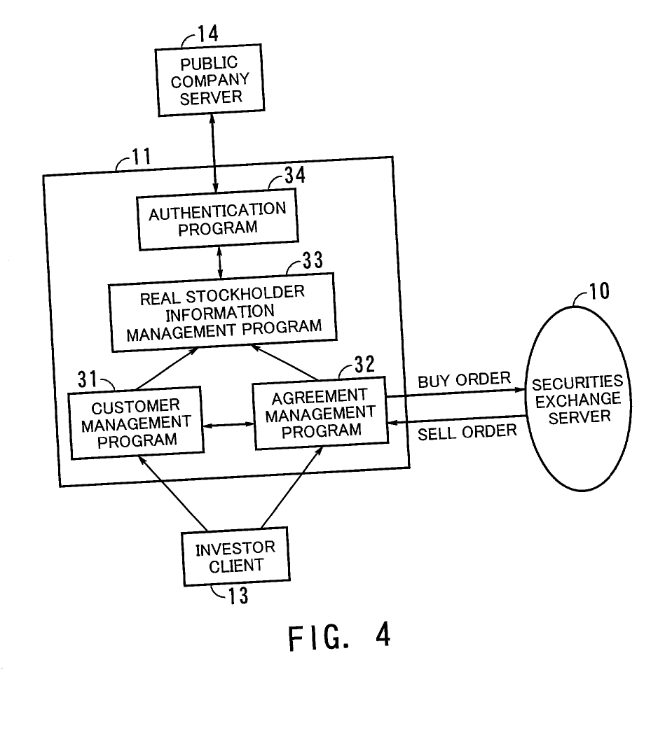

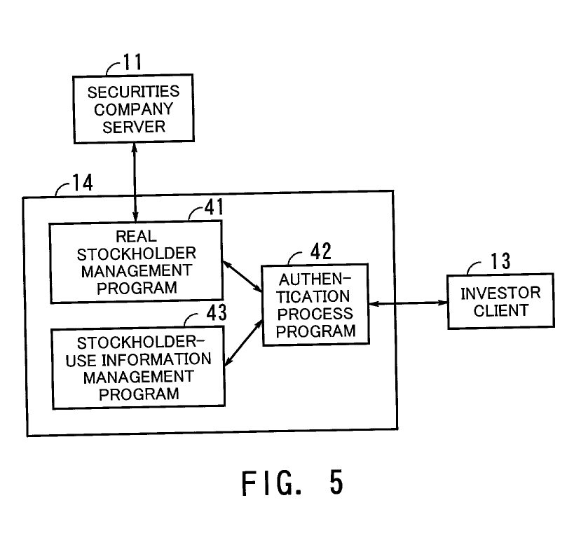

FIGS. 4 and 5 respectively illustrate functional blocks of the securities company server 11 and the public company server 14, both of which are working. As shown in FIG. 4, the securities company server 11 is made up of a customer management program 31, an agreement management program 32, a real stockholder information management program 33, and an authentication program 34.

The customer management program 31 manages, as customer information, attribute information (the details thereof will be described later) concerning investors who are customers. The agreement management program 32 manages information concerning an agreement that is made in the securities exchange server 10 when a buy order placed by the investor client 13 is matched with a sell order placed thereby or vice versa. The real stockholder information management program 33 manages the real holders of stocks (stockholders). When agreement with a buy order is made, the program 33 identifies the real stockholder by comparison with the customer management program 31.

More specifically, in the present specification, a “real holder” of stock (real stockholder) should be a person who belongs to any of the following three categories. Also, a stockholder who has transferred the stock and corresponds to a person of category (1) will be referred to as an absolute stockholder.

(1) This category of person has bought stock via the securities company and has transferred the stock to its own name upon request via the securities company. The person continuously holds the stock up to now.

(2) This category of person has bought stock and has applied for transfer of stock. The legal procedure for transfer of stock has not yet been completed. The person continuously holds the stock.

(3) This category of person has bought stock, but has not yet applied for transfer of stock. The person continuously holds the stock.

The authentication program 34 authenticates the right to access when receiving an inquiry about a real holder from the public company server 14.

FIG. 5 illustrates functional blocks of the public company server 14 that is working. As illustrated, the public company server 14 is made up of a real stockholder management program 41, an authentication process program 42, and a stockholder-use information management program 43.

The real stockholder management program 41 manages information concerning the real stockholders, which information is downloaded from the securities company server 11. The authentication process program 42 receives a request for access to the stockholder-use information management program 43 from the investor client 13, and executes an authentication process for determining whether the investor client 13 is a proper user. When it is determined that the investor client 13 is a proper user, the authentication process program 42 allows access to the stockholder-use information management program 43. The program 43 manages information to be supplied to the real stockholders such as information concerning a stockholders' meeting, business strategy and stockholders' preference.

Operation of the embodiment of the present invention is described below.

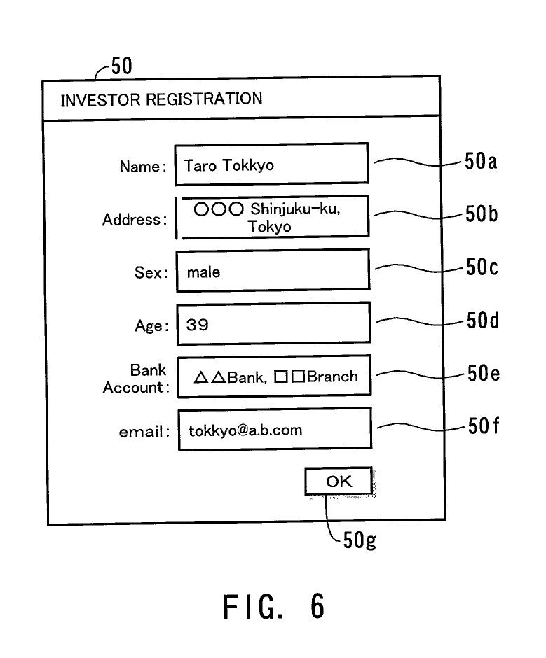

FIG. 6 illustrates an example of a screen 50 that is displayed when an investor is registered in the securities company as a customer. By way of example, a case will be described where the investor client 13-1 makes a record of a customer on the securities company.

Referring to FIG. 6, text boxes 50a through 50f appear on the screen 50. The text boxes 50a and 50b are respectively used to enter the name of the investor and his or her address. The text boxes 50c and 50d are respectively used to specify the distinction of sex of the investor and his or her age. The text box 50e is used to enter a bank account of the investor for settlement. The text box 50f is used to enter an e-mail address of the investor. An “OK” button 50g used to send the entered information to the securities company server 11-1 appears in the lowermost part on the screen 50.

After the items of information are entered on the screen 50 shown in FIG. 6, the “OK” button 50g is clicked. The items are sent to the securities company server 11-1 and are supplied to the customer management program 31 shown in FIG. 4.

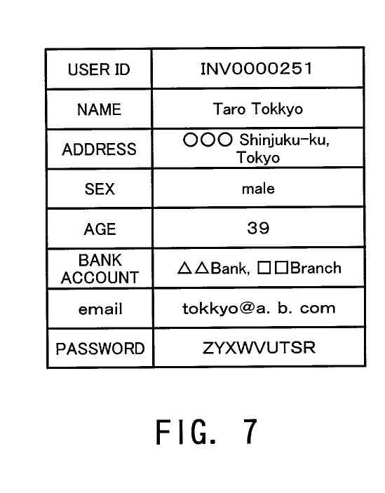

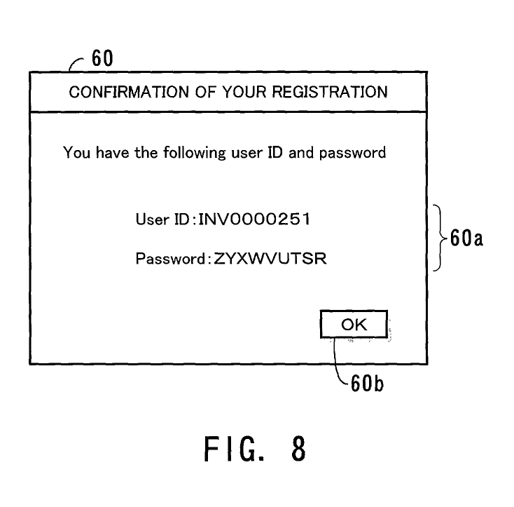

The customer management program 31 creates a user ID and a password, and associates these items with the received items. Then, the program 31 stores the associated items of information as customer information shown in FIG. 7. Also, the customer management program 31 sends the user ID and password back to the investor client 13-1. This results in a screen 60 at the investor client 13-1 shown in FIG. 8. The user ID and password are displayed in a display area on the screen 60. The investor checks the items on the screen 60, and knows his or her own user ID and password that have been assigned by the securities company server 11-1.

A description will be given of a process for buying a stock by the investor.

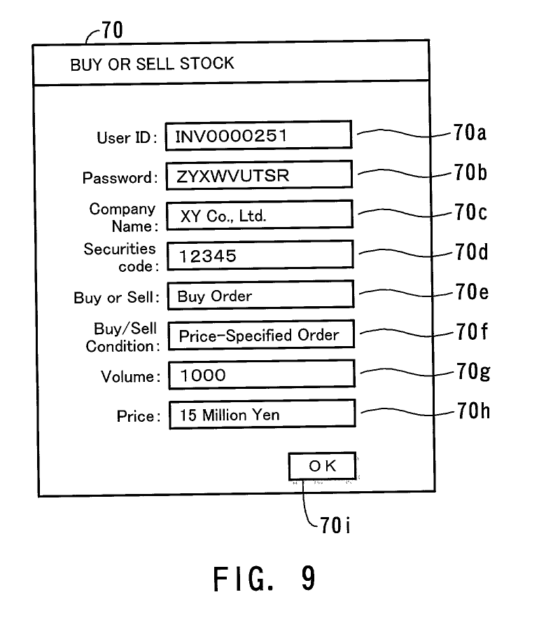

The investor operates the investor client 13-1 and has access to the securities company server 11-1 to request the buying of stock. This results in a screen 70 shown in FIG. 9 at the investor client 13-1. Text boxes 70a through 70h appear on the screen 70. The text boxes 70a and 70b are used to enter the user ID of the investor and his or her password, respectively. The text box 70c is used to enter the name of the company that issues stock which the investor attempts to buy. The text box 70d is used to enter a securities code, and the text box 70e is used to enter a transaction type. The text box 70f is used to enter a transaction condition. The text box 70g is used to enter a desired volume of stock, and the text box 70h is used to enter a desired price of stock. An “OK” button 70i appears on the lowermost part on the screen 70. The button 70i is clicked after the text boxes 70a through 70h are filled with the items, so that the corresponding buy order is sent to the securities company server 11-1.

The user ID and the password that are supplied to the investor via the screen 60 shown in FIG. 8 should be entered into the text boxes 70a and 70b, respectively. The company name is the name of a public company which lays stock open to the market that the investor attempts to buy. The securities code is a code assigned to the public company. The transaction type is a distinction of either a buy order or a sell order. The transaction condition is a distinction of either a price-specifying order or a discretionary order. A desired volume of stock is entered in the text box 70g. The text box 70h should be filled with a desired price only when the investor would like a limited order in which a desired price is specified.

After the necessary items are entered on the screen 70 shown in FIG. 9, the “OK” button 70i is clicked. Then, the buy order with the items is sent to the agreement management program 32 of the securities company server 11-1.

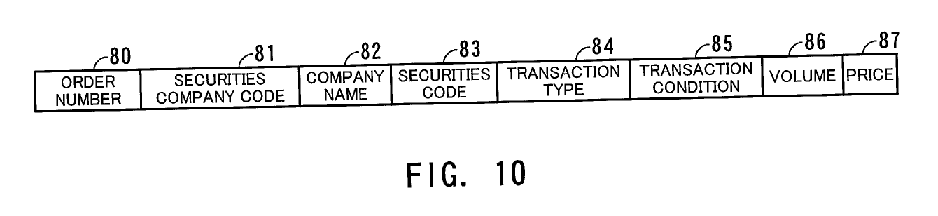

The agreement management program 32 produces data in a format shown in FIG. 10 from the received buy order, and sends a buy order to the securities exchange server 10. An order number 80 is a serial number that is automatically allotted, by the securities company server 11, to each buy or sell order placed in the securities exchange server 10. A securities company code 81 is a unique code indicative of a securities company that acts as an intermediary between the buy and sell orders. The items of information that have been entered on the screen 70 shown in FIG. 9 are arranged in the fields of a company name 82, a securities code 83, a transaction type 84, a transaction condition 85, a volume 86 and a price 87. The agreement management program 32 associates the buy and sell orders received from the investor client 13 with the buy and sell orders that have been sent to the securities exchange server 10.

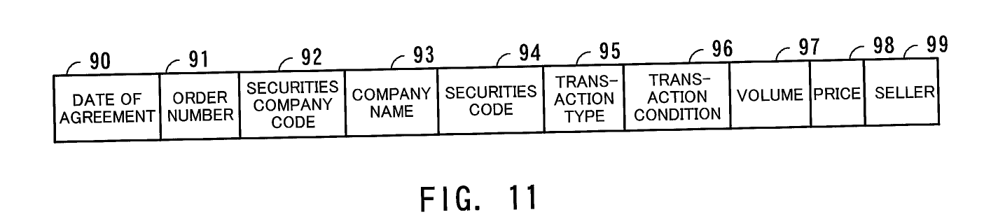

The buy or sell order (buy order in the present example) shown in FIG. 10 is sent to the securities exchange server 10, and is displayed on a so-called board screen specifically used for securities transactions. If there is a buy order that is matched with a sell order or vice versa, an agreement is made and data arranged in a format shown in FIG. 11 is sent to the agreement management program 32. The data shown in FIG. 11 includes the date of agreement 90 added to the head of the data arrangement shown in FIG. 10, and a seller 99 added to the tail thereof. The remaining items of data shown in FIG. 11 are the same as those shown in FIG. 10.

The agreement management program 32 receives the data shown in FIG. 11 and refers to the order number to thus identify the previously stored buy or sell order (see FIG. 10). Then, the agreement management program 32 notifies the real stockholder information management program that agreement has been made. As has been described previously, the buy or sell order from the investor client 13 and the buy or sell order sent to the securities exchange server 10 shown in FIG. 10 are associated with each other and are managed by the agreement management program 32. Thus, the user ID of the investor can be specified from the order number.

The real stockholder information management program 33 acquires, from the buy or sell order stored in the agreement management program 32, the user ID of the investor, the mane of the public company, and the securities code assigned to the stock certificates issued by this public company. Further, the program 33 acquires information about the customer from the customer management program 31. Then, the program 33 associates the information from the program 32 with the information from the program 31, and stores associated information as real stockholder information.

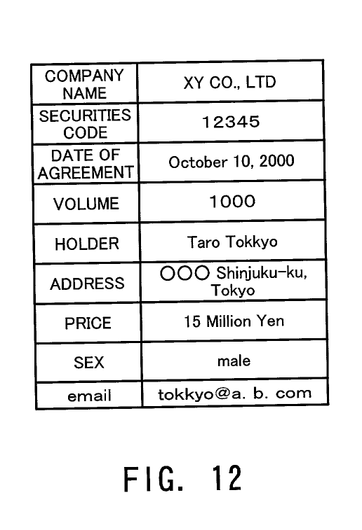

FIG. 12 illustrates an example of the real stockholder information. In this example, the real stockholder information includes items of information about the stock that has been bought and items of information concerning the real stockholder. The items of the stock information include the company name, securities code, date of agreement and volume. The items of the real stockholder information include the name of the stockholder, address, sex, age and e-mail address.

If the payment has not been made, the holder information may be deleted.

A description will be given of an operation in which the public company server 14 downloads the real stockholder information thus produced.

The public company server 14 accesses the securities company server 11-1 at given intervals and downloads the real stockholder information therefrom. At the commencement of the above operation, the real stockholder management program 41 shown in FIG. 5 is subjected to the authentication process by the authentication program 34 in the securities company server 11-1. If the right to access is confirmed, the real stockholder management program 41 accesses the real stockholder information program 33 to thus download the real stockholder information concerning the company's own stock.

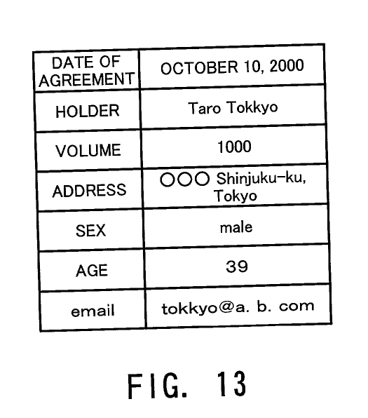

FIG. 13 illustrates an example of the downloaded information. In this example, the downloaded items of information are the stockholder, volume, address, sex, age and e-mail address. If a plurality of items of information concerning the same stockholder, these items may be gathered appropriately.

The information about the real stockholder thus produced is stored in the real stockholder management program 41.

A description will now be given of a process for sending various direct mails to the real stockholders by utilizing the information stored in the real stockholder management program 41.

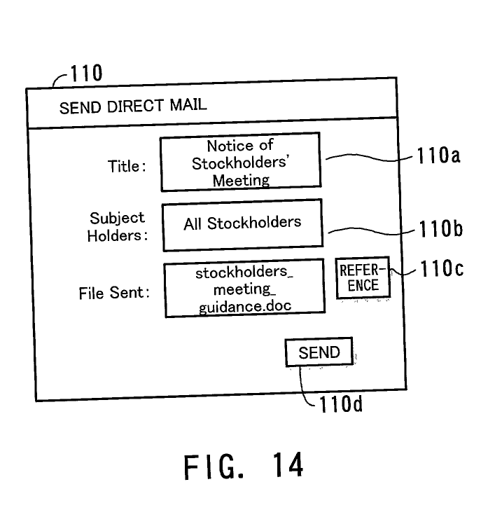

FIG. 14 is a screen for setting a recipient of a direct mail (e-mail) and the contents of the mail. A screen 110 shown in FIG. 14 has text boxes 110a through 110c, which are respectively used to enter a title of the direct mail, a subject stockholder and a file sent. A “send” button 110d appears in the lowermost part on the screen 110. The “send” button 110d is clicked to send the e-mail having the above contents to the specified stockholders.

The title on the screen 110 is a title of the direct mail. The subject stockholder is a condition for selecting a stockholder to which the direct mail should be sent. In the example illustrated in FIG. 14, all stockholders are specified. It is also possible to specify limited stockholders that are based on, for example, the number of stock certificates. The file sent is information described in the body of the mail. In the example, “stockholders_meeting_guidance.doc”, which is a document file, is specified.

When the “send” button 110d is clicked, an e-mail is created which has a body formed by the contents of the file specified as a file sent. Subsequently, the real stockholder information stored in the real stockholder management program 41 is retrieved to search for the stockholders that meet the condition. The stockholders thus chosen are set as recipients.

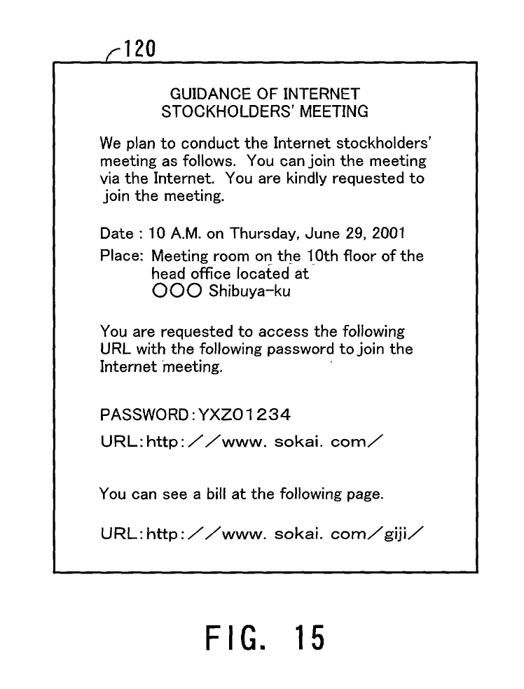

FIG. 15 shows an example of the e-mail thus created via the screen 110. In this example, the e-mail shows items of information with regard to the stockholders' meeting to be held, an Internet stockholders' meeting and a bill.

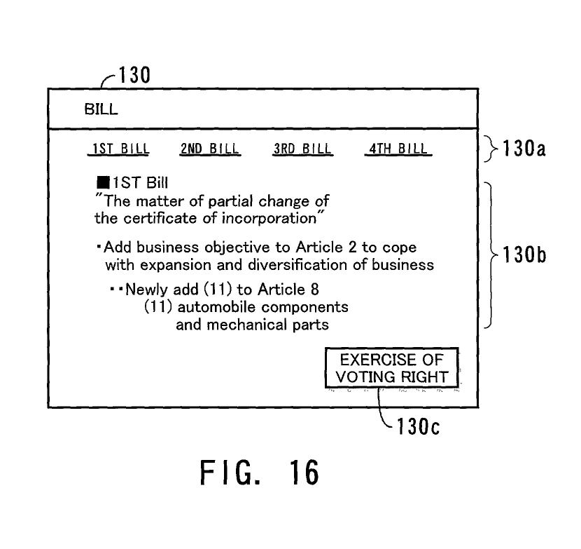

The investor client 13-1 receives the e-mail, and the user clicks a URL (Uniform Resource Locator) for accessing a page of the bill. This activates a browser, which displays a screen 130 shown in FIG. 16.

A list of hot texts, which are respectively associated with different bills, is displayed in a display area 130a. If one of the hot texts is clicked, the user will see the contents of the corresponding bill. The details of the first bill are displayed in a display area 130b. An “exercise of voting right” button 130c appears in the lowermost part on the screen 130. The button 130c is clicked when the voting right is exercised.

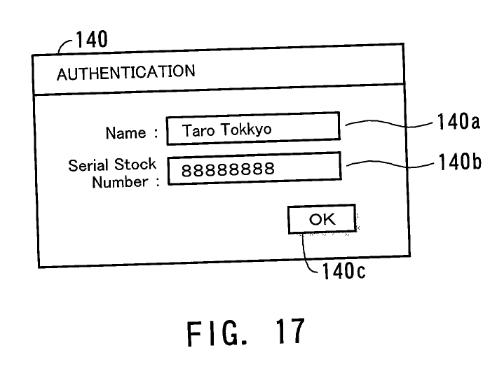

When the “exercise of voting right” button 130c is clicked on the screen 130, a screen 140 shown in FIG. 17 is displayed and waits for entering of authentication information. In this example, text boxes 140a and 140b appear on the screen 140 via which the name of the real stockholder and the stock identification number are entered, respectively. An “OK” button 140c appears in the lowermost part on the screen 140. The serial stock number is a serial number serially assigned to stock on the share basis. Each stockholder made of record is notified of the serial stock number of stock certificates. Each stockholder is allowed to exercise the voting right in the general meeting only when he or she has been made of record. The serial stock number is used to determine whether the stockholder has been made of record with the serial stock number to have the voting right.

The items are entered on the screen 140 and the “OK” button 140c is clicked. This causes the authentication information to be sent to the public company server 14, which executes the authentication process program 42. The serial stock number may be manually input to the real stockholder management program 41 at the time of making a record. Alternatively, the stockholder list may be acquired from the trust bank and an arbitrary one of the serial stock numbers may be chosen and registered.

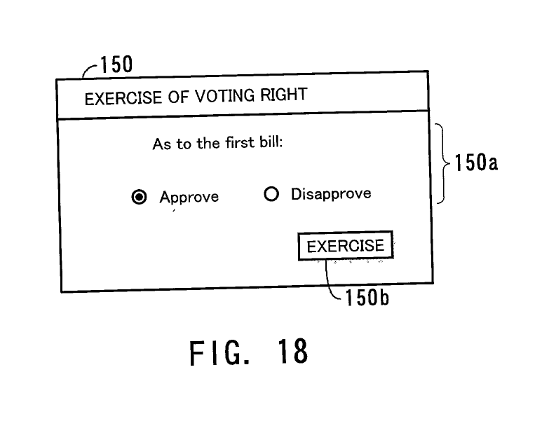

When the authentication is successful, a screen 150 shown in FIG. 18 is displayed at the investor client 13-1. In this example, radio buttons for specifying a distinction of approval or disapproval of the first bill are displayed in a display area 150a on the screen 150. If the investor approves of the first bill, he or she clicks the corresponding radio button. If the investor disapproves of the first bill, he or she clicks the corresponding radio button. Then, an “exercise” button 150b is clicked. This sends information indicating approval/disapproval of the first bill to the public company server 14.

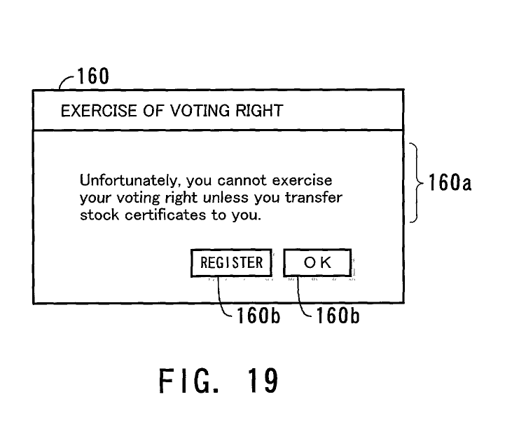

If the investor who does not have any serial stock number attempts to exercise the voting right, a screen 160 shown in FIG. 19 will be displayed at the investor client 13-1. The above-mentioned process might allow a situation in which the investor who does not have the voting right is informed of the place in which the general meeting is held. This might cause an unwanted trouble. In order to avoid this trouble, the screen 160 may be displayed immediately after the screen 110 shown in FIG. 14 is displayed. If the transfer of stock has not been made of record, a “register” button 160c is clicked so that the investor can voluntarily register the transfer of stock to his or her name.

A description will be given of a process for sending materials for business strategy of the public company to stockholders via a direct mail, such materials serving as IR (Investor Relations) information.

It can be said that the public company preferably discloses information concerning the business strategy to thus provide the stockholders with information that is useful to make a decision as to whether the stock should be continuously held. The disclosure of such information would contribute to establishing a relationship of mutual trust. Conventionally, the IR information is disclosed to only the stockholders of record (absolute stockholders who belong to the aforementioned category (1)). However, it is desirable to disclose useful information to stockholders who belong to the other categories (the aforementioned category (2) or (3)).

According to the present embodiment, the direct mail is positively utilized to disclose the IR information to the real stockholders other than the absolute stockholders. An embodiment of the present invention directed to positive use of the direct mail is described immediately below.

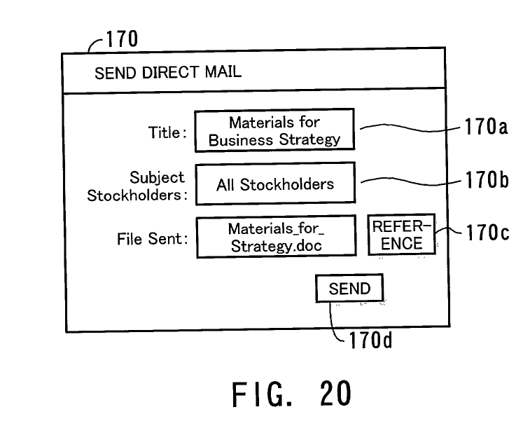

FIG. 20 illustrates an example of a screen 170 used to set a condition for sending the IR information to the real stockholders via the direct mail. The contents of the screen 170 are the same as those shown in FIG. 14, and a description thereof will not be repeated here.

In the example shown in FIG. 20, “materials for business strategy” is entered into a text box 170a as the title of direct mail. As the subject stockholders, “all stockholders” are specified in an associated text box 170b. As a file sent, “materials_for_strategy.doc” is specified in an associated text box 170c.

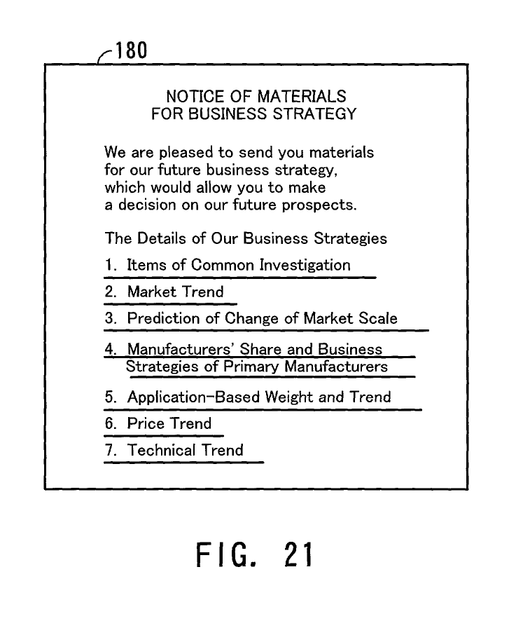

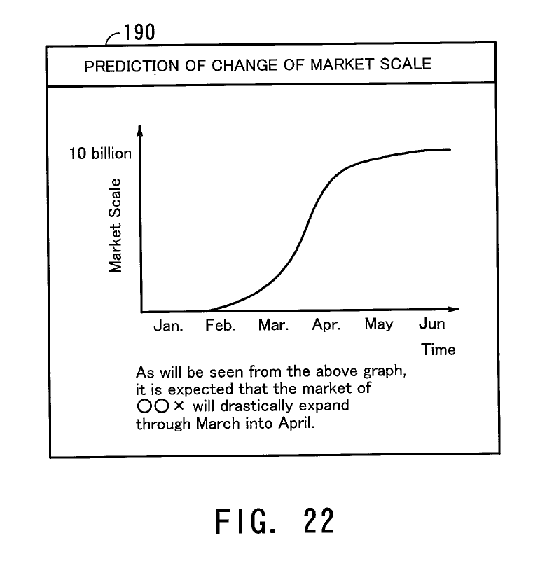

These items of information are entered on the screen 170, and a “send” button 170d is clicked. Thus, a mail 180 shown in FIG. 21 is sent to the investor clients. The mail 180 includes a message of sending information concerning a business strategy, and the details of the business strategy. Items of the business strategy information are formed by hot texts. If an arbitrary one of the items of the business strategy information is clicked, a corresponding homepage will be automatically accessed. For example, if a hot text titled “3. Prediction of Change of Market Scale” is clicked, the browser will be activated and a screen 190 shown in FIG. 22 will be displayed.

As shown in FIG. 22, a graph indicating a prediction of change of the market scale is displayed on the screen 190. A comment on the prediction of change of the market scale is shown in the lowermost part on the screen 190. The real stockholder would see the screen 190 and know the business strategy.

A description will now be given of an operation of sending information about stockholders' preference to the real stockholders.

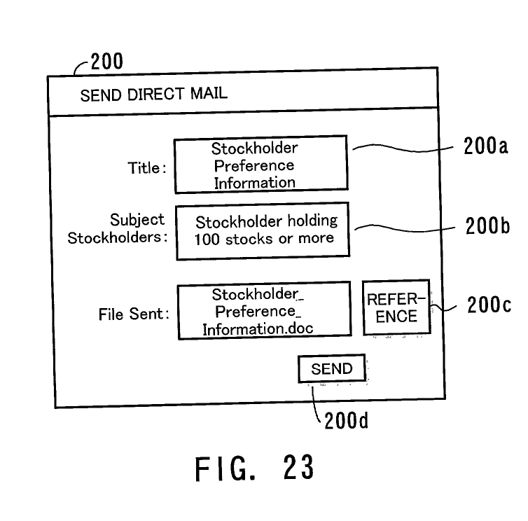

FIG. 23 illustrates an example of a screen 200, which is created when a direct mail including stockholders' preference information is sent to specified stockholders. The details of the screen 200 are the same as those of the screen 110 shown in FIG. 14, and a description thereof will not be repeated here.

In this example, “stockholder preference information” is put in a text box 200a for entering the title of direct mail. As the subject stockholders, “100 stocks or more” is entered into an associated text box 200b. As a file sent, “stockholder_preference information.doc” is input to a box 200c.

When a “send” button 200d is clicked, a mail is created which has a body formed by the contents of the file specified as a file sent. Subsequently, stockholders who own 100 shares or more are chosen from information concerning the real stockholders stored in the real stockholders management program 41, and are designated as recipients. Then, the mail is sent to the specified stockholders.

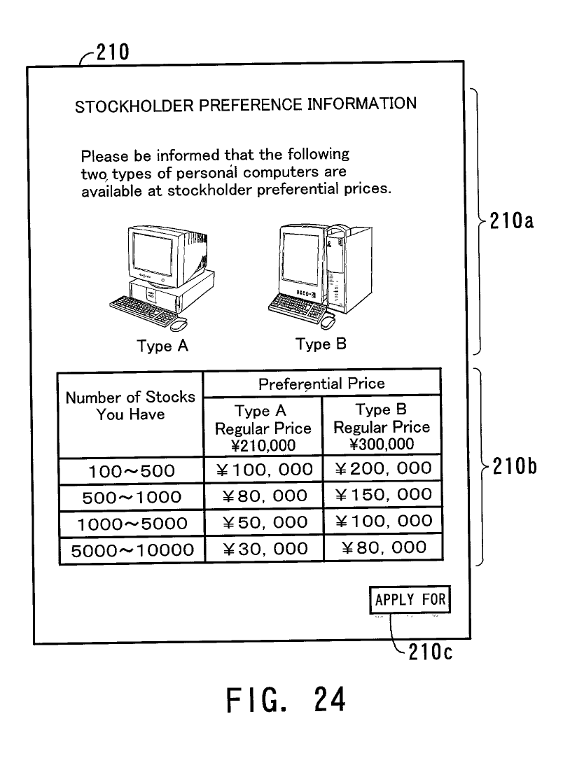

FIG. 24 illustrates an example of an e-mail 210 created via the screen 200 shown in FIG. 200. In this example, the screen 210 has a display area 210a, which shows that two different types of personal computers are on sale at preferential prices. A display area 210b shows a list of a relationship between the volume of stock owned and the preferential price. An “apply for” button 210c, which is clicked when applied for, appears on the lowermost part on the screen 210.

An investor who wishes to buy a personal computer via the direct mail clicks the “apply” button 210c. This causes a homepage linked with the “apply” button 210c to be displayed on the browser.

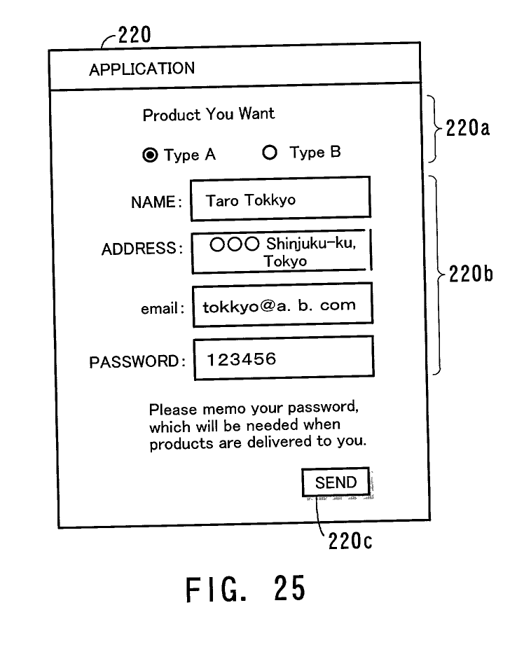

FIG. 25 illustrates an example of a screen 220 displayed at that time. Radio buttons for specifying a desired type of personal computer appear in a display area 220a. Text boxes are displayed in a display area 220b for entering the name of the applicant, his/her address, e-mail address and password.

The necessary items of information are entered on the screen 200, and a “send” button 220c is clicked. Then, the items of information that have been input are sent to the public company server 14. The authentication process program 42 of the public company server 14 looks up the information concerning the real stockholders managed by the real stockholder management program 41, and determines whether the stockholder of interest is a proper stockholder. If the answer is affirmative, the application will be processed.

As described above, the present embodiment compares the customer information stored in the securities company server 11-1 with the agreement information to thereby identify the real stockholders and manage information about the real stockholder. This makes it possible to know the real stockholders immediately.

Also, according to the present embodiment, the real stockholder information acquired by the securities server 11-1 can be downloaded by the public company server 14. This makes it possible to supply the real stockholders with a variety of information and service.

Further, according to the present embodiment, the serial stock number that is allotted when the investor is made of record is used as a password. This makes it possible to simply make a decision as to whether each stockholder is a stockholder of record. Thus, each stockholder can easily know whether he or she has the voting right in the stockholders' meeting.

In the foregoing embodiment, the direct mail (e-mail) is sent based on the information about the real stockholders of record in the public company server 14. Alternatively, a mail may be sent via postal service.

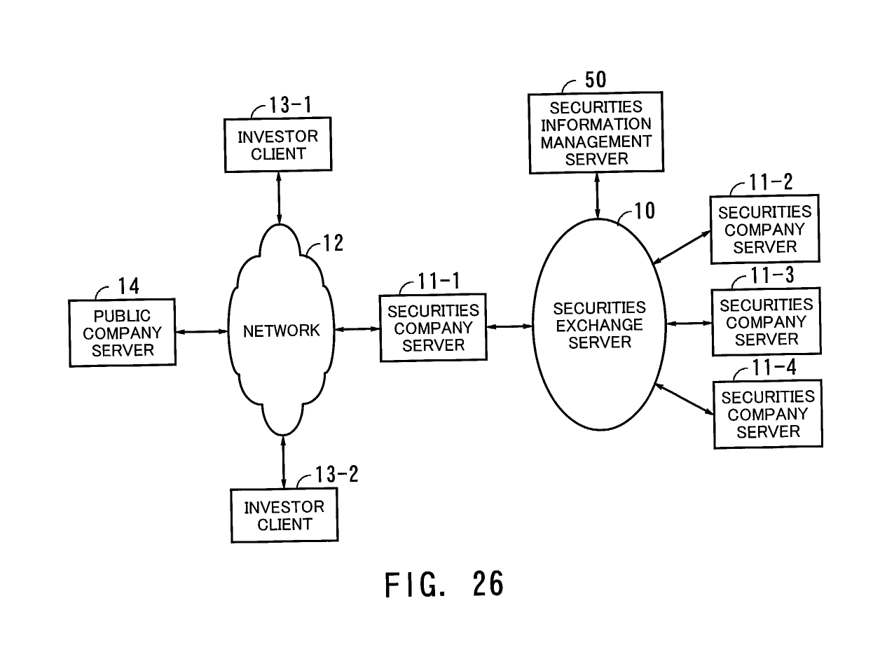

In the foregoing, each securities company server is equipped with the real stockholder information management program for identifying the real stockholders. Alternatively, as shown in FIG. 26, a securities information management server 51 may be newly introduced and integrally manage the real stockholder information. This avoids the securities company servers from managing the real stockholder information separately and independently, and facilitates rationalization of the whole system.

A description will be given of flowcharts that describe processes executed in the above-mentioned embodiment of the present invention.

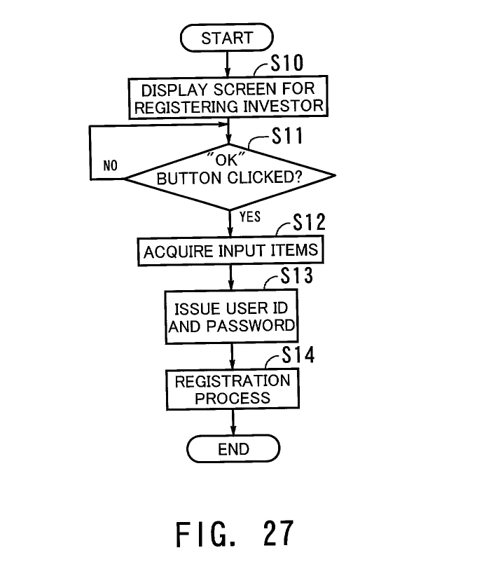

FIG. 27 is a flowchart of an example of a process that is executed by the securities server 11 when customer information about the investors is registered. This process starts with step S10.

[S10] The customer management program 31 causes the investor client 13 to display the screen 50 for making a record of investors shown in FIG. 6.

[S11] The program 31 determines whether the “OK” button 50g has been clicked. The program 31 proceeds to step S12 if the answer is YES, and repeats this step if the answer is NO.

[S12] The program 31 acquires the items that have been entered on the screen 50.

[S13] The program 31 issues a user ID and a password.

[S14] The program 31 executes a process for making a record of the input items as customer information.

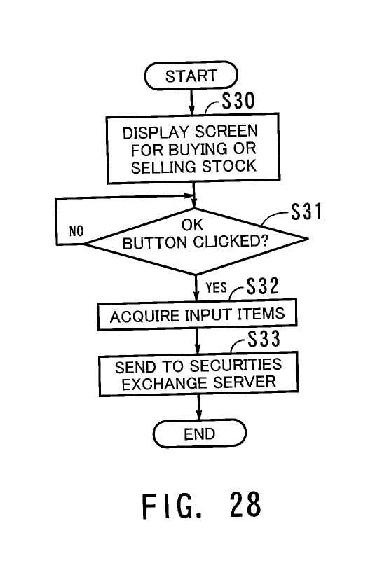

A description will be given, with reference to FIG. 28, of a process that is executed by the securities company server 11 for the buying of stock. This process starts with step S30.

[S30] The agreement management program 32 causes the screen 70 for the buying or selling of stock shown in FIG. 9 to be displayed at the investor client 13.

[S31] The program 32 determines whether the “OK” button 70i has been clicked. The program 32 proceeds to step S32 if the answer of this step is YES, and repeats this step if the answer is NO.

[S32] The program 32 acquires the items that have been entered on the screen 70 shown in FIG. 9.

[S33] The program 32 produces data in the format shown in FIG. 10 from the acquired items, and sends the data to the securities exchange server 10. At that time, the program 32 stores a buy or sell order including a newly assigned order number and a buy or sell order including the user ID received from the investor client 13 in association with each other.

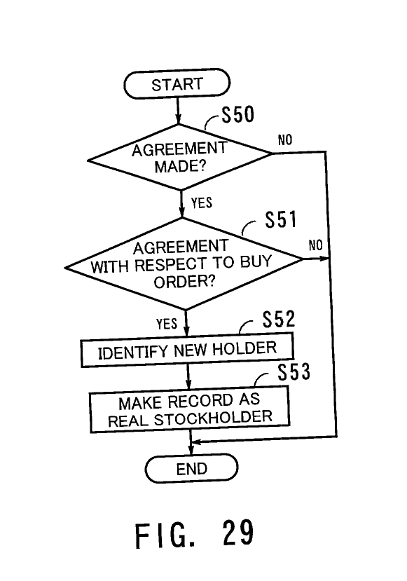

A description will now be given, with reference to FIG. 29, of an example of a process that is executed by the securities company server 11 when agreement is made in the securities exchange server 10. This process starts with step S50.

[S50] The real stockholder information management program 33 refers to the agreement management program 32 and determines whether agreement has been made. The program 33 proceeds to step S51 if the answer is YES, and ends the process if the answer is NO.

[S51] The program 33 determines whether an agreement with a buy order has been made. The program 33 proceeds to step S52 if the answer is YES, and ends the process if the answer is NO.

[S52] The program 33 refers to the customer management program 31 and identifies a new stockholder.

[S53] The program 33 makes a record of the new stockholder as a new real stockholder.

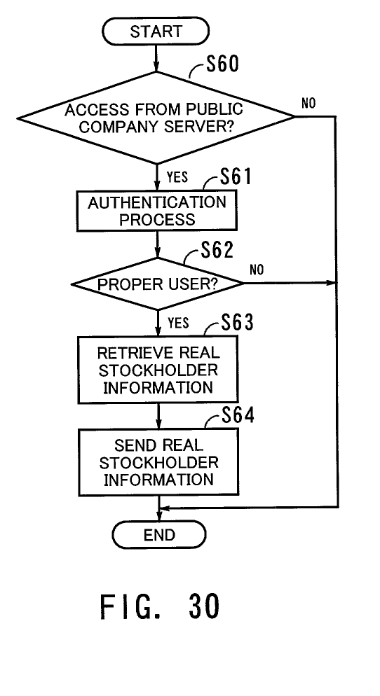

A description will now be given, with reference to FIG. 30, of an example of a process that is executed by the securities company server 11 when the public company server 14 makes a request to download information concerning the real stockholders. This process starts with step S60.

[S60] The authentication program 34 determines whether access from the public company server 14 has been received. The program proceeds to step S61 if the answer is YES, and ends the process if the answer is NO.

[S61] The program 34 executes the authentication process for determining whether the public company server 14 that has accessed the securities company serer 11 is a proper user.

[S62] The program 34 determines whether the public company server 14 is a proper user on the basis of the results of execution of the authentication process. The program proceeds to step S63 if the answer is YES, and ends the process if the answer is NO.

[S63] The real stockholder information management program 33 retrieves the real stockholder information to search for the real stockholders of stocks that are laid open by the public company that owns the server 14.

[S64] The program 33 sends the real stockholder information acquired in step S63 to the public company server 14.

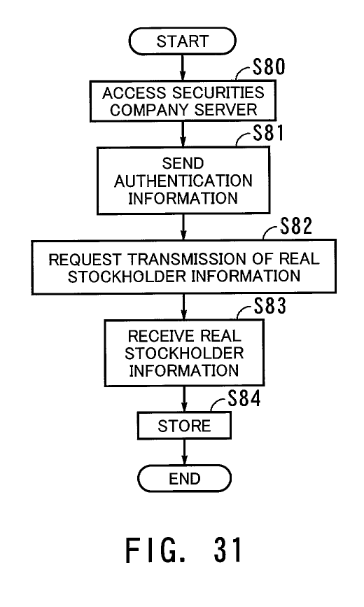

A description will now be given, with reference to FIG. 31, of an example of a process that is executed by the public company server 14 when downloading the real stockholder information from the securities company server 11. The process begins with step S80.

[S80] The real stockholder management program 41 accesses the securities company server 11. The real stockholder information may be dispersed to and stored in a plurality of securities company servers. Therefore, it is necessary to have access to all the securities company servers.

[S81] The program 41 sends authentication information to the securities company server 11.

[S82] The program 41 requests the securities company server 11 to send the real stockholder information.

[S83] The program 41 receives the real stockholder information from the securities company server 11. p1 [S84] If a plurality of items of information concerning the same stockholder are received, the program 41 executes a process for gathering these items of information and storing the gathered items.

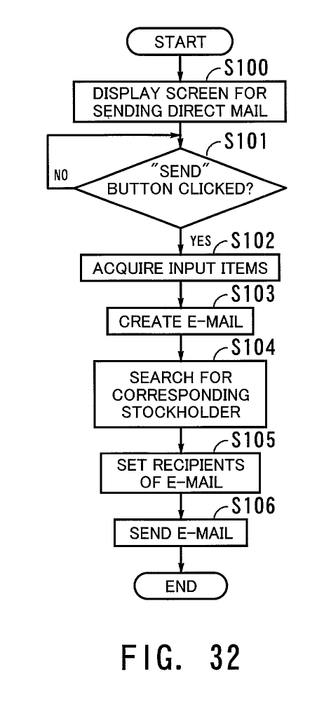

A description will now be given, with reference to FIG. 32, of an example of a process that is executed by the public company server 14 when a direct mail is sent to the real stockholders. This process starts with step S100.

[S100] The stockholder-use information management program 43 causes the display unit to display the screen 110 used for sending the direct mail shown in FIG. 14.

[S101] The program 43 determines whether the “send” button 110d has been clicked. The program 43 proceeds to step S102 if the answer is YES, and repeats this step if the answer is NO.

[S102] The program 43 acquires the items that have been input on the screen 110.

[S103] The program 43 creates an e-mail having the title formed by information entered in the text box 110a and the body formed by information entered in the text box 110c.

[S104] The program 43 refers to the real stockholder management program, and searches for real stockholders that are matched with the condition entered in the text box 110b.

[S105] The program 43 sets the real stockholders as recipients of the respective e-mails.

[S106] The program 43 sends the e-mails.

The programs described in the above-mentioned flowcharts implement the functions that have been described with reference to FIG. 2.

The present invention can be implemented by computers. In this case, the processes executed by the authentication apparatus and the information processing apparatus are described in programs recorded on a computer-readable recording medium or media. The above-mentioned processes can be implemented when the computers execute the programs. Typical examples of a computer-readable recording medium are a magnetic recording apparatus and a semiconductor memory. The programs may be stored in a portable recording medium such as a CD-ROM (Compact Disk Read Only Memory) or a floppy disk, which is easily available in the market. It is also possible to store the program in a storage device of a computer connected to a network and to transfer it to another computer through the network. When the computer executes the program, it is read from a hard disk drive or the like built in or externally connected to the computer and is loaded to the main memory.

As described above, according to the present invention, the authentication process for authenticating a holder of securities includes the steps of: storing customer information concerning customers in a storage unit; acquiring transaction information concerning a transaction that has been agreed in an exchange; and identifying a holder of securities after the transaction by comparing the transaction information with the customer information. Thus, the real holder of securities after transaction can be identified immediately.

Also, the present invention includes a method for performing an information process using holder information concerning a holder obtained by an authentication apparatus which authenticates a holder of securities. This method includes the steps of: acquiring the holder information; storing the holder information in a storage unit; and selecting a given item of holder information from among the holder information stored in the storage unit and sending given information to a holder related to the given item of holder information selected. Hence, the real holder of securities can be supplied with useful information.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A method for authenticating a holder of securities comprising the steps of:
storing customer information concerning customers in a storage unit;
acquiring transaction information concerning a transaction that has been agreed in an exchange; and
identifying a holder of securities after the transaction by comparing the transaction information with the customer information.

2. The method according to claim 1, further comprising the steps of:
associating holder information concerning the holder identified with information concerning a person who issues securities and storing associated information in the storage unit; and
retrieving the associated information when the person who issues securities requests a retrieval and searching for information concerning a related holder.

3. The method according to claim 2, further comprising the steps of:
determining whether the holder of securities after the transaction has paid an amount by a given deadline; and
deleting the holder information concerning said holder of securities from the storage unit when it is determined that the amount has not been paid by the given deadline.

4. A computer-readable recording medium storing a program that causes a computer to implement a process for authenticating a holder of securities, said program causing the computer to function as:
means for storing customer information concerning customers in a storage unit;
means for acquiring transaction information concerning a transaction that has been agreed in an exchange; and
means for identifying a holder of securities after the transaction by comparing the transaction information with the customer information.

5. An authentication apparatus comprising:
means for storing customer information concerning customers in a storage unit;
means for acquiring transaction information concerning a transaction that has been agreed in an exchange; and
means for identifying a holder of securities after the transaction by comparing the transaction information with the customer information.

6. A method for performing an information process using holder information concerning a holder obtained by an authentication apparatus which authenticates a holder of securities, said method comprising the steps of:
acquiring the holder information;
storing the holder information in a storage unit; and
selecting a given item of holder information from among the holder information stored in the storage unit and sending given information to a holder related to the given item of holder information selected.

7. The information processing method according to claim 6, wherein said given information includes an IR (Investor Relations) information.

8. The information processing method according to claim 6, wherein:
the securities are stock certificates; and
said given information is related to stockholders of stocks.

9. The information processing method according to claim 6, wherein:
the holder information includes information about the number of securities on a stockholder basis; and
the information processing method further comprises the steps of selecting holders on the basis of information about the number of securities and sending the given information to only the holders selected.

10. The information processing method according to claim 6, wherein:
the holder information includes information about a serial number assigned to each of the securities; and
the information processing method further comprises the steps of selecting holders on the basis of information about the serial number and sending the given information to only the holders selected.

11. A computer-readable recording medium recording a program that causes a computer to execute a given information process by using holder information concerning a holder of securities obtained by an authentication apparatus that authenticates the holder of securities, said program causing the computer to function as:
means for acquiring the holder information;
means for storing the holder information in a storage unit; and
means for selecting a given item of holder information from among the holder information stored in the storage unit and sending given information to a holder related to the given item of holder information selected.

12. An information processing apparatus that executes an information process by using holder information concerning a holder of securities obtained by an authentication apparatus that authenticates the holder of securities, said information processing apparatus comprising:
means for acquiring the holder information;
means for storing the holder information in a storage unit; and
means for selecting a given item of holder information from among the holder information stored in the storage unit and sending given information to a holder related to the given item of holder information selected.
